(19) United States
(12) Patent Application Publication
(10) Pub. No.: US 2006/0018334 A1
(43) Pub. Date: Jan. 26, 2006

(54) Communication/broadcast multiplexer and demultiplexer used in communication/broadcast-integrated system

(75) Inventors: Jae-Hun Cho, Suwon-si (KR); Yun-Je Oh, Yongin-si (KR); Jun-Ho Koh, Suwon-si (KR); Ki-Cheol Lee, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/005,590

(22) Filed: Dec. 6, 2004

(30) Foreign Application Priority Data
Jul. 22, 2004 (KR) 2004-57281

(51) Int. Cl. H04J 3/26

(52) U.S. Cl. 370/432

(57) ABSTRACT

A communication/broadcast multiplexer and demultiplexer for multiplexing and demultiplexing communication and broadcast signals using a specific transmission standard in an optical network system that integrates broadcast and communication services using a channel selection technique. The multiplexer comprises a broadcast data input unit, a communication data input unit, and a synchronous Ethernet framer. The broadcast data input unit receives broadcast data switched on a subscriber basis through a broadcast switch in an optical line terminal (OLT) in the system, and transfers it as a synchronous data frame to the synchronous Ethernet framer. The communication data input unit receives communication data on a subscriber basis through an Ethernet switch in the OLT and transfers it as an asynchronous data frame to the synchronous Ethernet framer. The synchronous Ethernet framer converts both the received synchronous and asynchronous data frames into a TDM synchronous Ethernet frame, and outputs the TDM synchronous Ethernet frame.

### CLAIM OF PRIORITY

This application claims priority to an application entitled “COMMUNICATION/BROADCAST MULTIPLEXER AND DEMULTIPLEXER USED IN COMMUNICATION/BROADCAST-INTEGRATED SYSTEM,” filed in the Korean Intellectual Property Office on Jul. 22, 2004 and assigned Serial No. 2004-57281, the contents of which are incorporated herein by reference.

### BACKGROUND OF THE INVENTION

1. Field of the Invention

The present invention relates to a Passive Optical Network (PON) using Wavelength Division Multiplexing (WDM).

2. Description of the Related Art

Many broadcast and communication service subscribers currently use data communication services such as Internet. Typically the data rates for such services are several tens of Kbps (bits per second) to several tens of Mbps through xDSL, a cable modem, a dial-up modem, metro-Ethernet, etc. They also use broadcasting services such as cable broadcasting through a coaxial cable, satellite broadcasting through a satellite, terrestrial broadcasting, etc.

Data rates of about 100 Mbps are required to effectively provide subscribers with services such as high-capacity image information, Video on Demand (VoD), and high-quality digital broadcasts. However, the prior art has many limitations in accommodating such data in terms of its capacity and speed. This increases the need to implement an optical network using optical communication. PON technology has been proposed and developed as the most economic way to implement the optical network.

The PON is classified mainly into an Asynchronous Transfer Mode (ATM)-PON, an Ethernet-PON, and a WDM-PON according to its implementation methods.

Among them, the ATM-PON and Ethernet PON have problems in that they have no transparency about the speed of data to be provided to subscribers. Further they use an Optical Line Terminal (OLT), which requires complicated Media Access Control (MAC) technologies because it uses the same wavelength in upstream transmission. The ATM-PON and Ethernet PON also have difficulties in accommodating digital broadcasts.

On the other hand, the WDM-PON has no limitation on the speed of data that can be provided to the subscribers. Also, it does not require the complicated MAC technology since it uses different wavelengths in upstream and downstream transmissions. It is also easy for the WDM-PON to accommodate digital broadcasting services. Thus, there is a need for the WDM-PON to be developed for the provision of broadcast/communication-integrated services.

FIG. 1 shows the configuration of one conventional WDM-PON that can integrate broadcast and communication. As shown, the WDM-PON includes an OLT (Optical Line Terminal) 11, ONT/ONUs (Optical Network Terminal/Optical Network Units) 12, an optical splitter 15, a photoelectric (or optical-to-electrical) converter (O/E) 16, an RF (Radio Frequency) splitter 17, a WDM demultiplexer 13, and a WDM multiplexer 14. The OLT 11 is connected to a broadcasting network for broadcasting services and an IP (Internet Protocol) network for communication services. The OLT 11 receives broadcast signals from the broadcasting network and communication signals from the IP network, and transmits the received signals as optical signals after photoelectric conversion. In addition, the OLT 11 transfers communication signals, received from service subscribers, to the IP network. The ONT/ONUs 12 are devices on the user side for transferring the broadcast and communication signals, received from the OLT 11, to service users and transferring communication signals from the service users to the OLT 11. The optical splitter 15 splits the broadcast and communication signals from the OLT 11 into a broadcast signal λ_{A} and communication signals λ₁ to λ₃₂. The photoelectric converter 16 photoelectrically converts the broadcast signal λ_{A} split through the optical splitter 15. The RF splitter 17 distributes the converted electric broadcast signal to each of the ONT/ONUs 12. The WDM demultiplexer 13 WDM-demultiplexes the communication signals λ₁ to λ₃₂ from the OLT 11, and transfers them to the ONT/ONUs 12. The WDM multiplexer 14 WDM-multiplexes the communication signals λ₁ to λ₃₂ from the ONT/ONUs 12, and transfers them to the OLT 11.

A conventional WDM-PON operates in the following manner. The WDM-PON uses λ₁ to λ₃₂ as wavelength channels for communication, and uses λ_{A} as a wavelength channel for broadcasting.

In the conventional WDM-PON shown in FIG. 1, a broadcast signal of λ_{A} in downstream transmission is optically split through the optical splitter 15 in a front end of the WDM demultiplexer 13. Then, it is photoelectrically converted in the photoelectric converter (O/E) 16. After the converted signal is separated into respective broadcast signals for service users through the RF splitter 17, they are transmitted to the respective service users through a coaxial cable.

On the other hand, communication signals of λ₁ to λ₃₂ are transmitted to the respective service users after being demultiplexed in the wavelength demultiplexer 13 on a wavelength-by-wavelength basis.

In this conventional WDM-PON, broadcast and communication signals are not integrated and transmitted through one wavelength. Instead, analog and digital broadcast signals are integrated and transmitted through one wavelength λ_{A}. Communication signals are transmitted to subscribers through different wavelengths λ₁ to λ₃₂, respectively. That is, the conventional WDM-PON cannot integrate broadcast and communication signals into a single signal to provide broadcast and communication services.

In the conventional WDM-PON shown in FIG. 1, the optically-split broadcast signal λ_{A} is photoelectrically converted, and its analog and digital broadcast signals are transmitted through a cable network. The cable network has been installed to provide the conventional broadcasting services defined in bands of up to around 550 MHz. However, existing cable networks cannot accommodate analog/digital broadcasts. This is because the domestic digital cable broadcasting standard was established to have a band around 850 MHz for carrying a broadcast signal including analog and digital broadcasts.

The conventional WDM-PON of FIG. 1 thus has a problem in that the accommodation of analog/digital broadcasts requires replacement of a lead-in coaxial cable in each subscriber with a coaxial cable of an extended band. Alternatively, it requires installation of a new extension coaxial cable with the existing coaxial cable being retained.

FIG. 2 shows the configuration of another conventional WDM-PON that can integrate broadcast and communication. As shown, the WDM-PON includes an OLT 21, ONT/ONUs 22, a WDM demultiplexer 23, and a WDM multiplexer 24. The OLT 21 is connected to a broadcasting network for broadcasting services and an IP network for communication services. The OLT 21 receives broadcast signals from the broadcasting network and communication signals from the IP network, and transmits the received signals as optical signals after photoelectric conversion. The OLT 21 also transfers communication signals, received from service subscribers, to the IP network. The ONT/ONUs 22 are devices on the user side for transferring the broadcast and communication signals, received from the OLT 21, to service users, and transferring communication signals from the service users to the OLT 21. The WDM demultiplexer 23 WDM-demultiplexes both the communication signals λ₁ to λ₃₂ and the broadcast signals λ₃₃ to λ₆₄, and transfers them to the ONT/ONUs 22. The WDM multiplexer 24 WDM-multiplexes the communication signals λ₁ to λ₃₂ from the ONT/ONUs 22, and transfers them to the OLT 21.

The conventional WDM-PON of FIG. 2 can provide high-capacity data communication and broadcasting services because a wavelength for broadcasting and a wavelength for communication are provided individually to each subscriber. However, as with the prior art of FIG. 1, the WDM-PON of FIG. 2 does not suggest a technology for integrating and transmitting broadcast and communication signals. In addition, the conventional WDM-PON of FIG. 2 must include twice as many optical transmitters as the conventional WDM-PON of FIG. 1. Further, each subscriber must use two optical receivers in order to receive both the wavelength signals for communication and broadcasting. This increases the cost of the WDM-PON system, imposing a burden on the subscribers. The number of wavelengths used in the WDM-PON coincides with the number of subscribers that can be handled by the WDM-PON. Thus, the number of subscribers, which can be handled by the WDM-PON, is cut in half, compared to the prior art of FIG. 1, because each subscriber uses two wavelengths.

To overcome the above problems, an application (Serial No. 2003-16373) has been filed in the Korean Intellectual Property Office, which suggests a PON (Passive Optical Network) wherein signals for digital broadcasting and communication services are integrated and transmitted using WDM (Wavelength Division Multiplexing).

FIG. 3 shows the configuration of a WDM-PON capable of integrating broadcast and communication according to Korean application No. 2003-16373. As shown, the WDM-PON includes an OLT 31, ONT/ONUs 32, a WDM demultiplexer 33, and a WDM multiplexer 34. The OLT 31 is connected to a digital broadcasting network for broadcasting services, (which is also referred to as a “broadcasting network” in the following description), and an IP network for communication services. The OLT 31 receives digital broadcast signals from the broadcasting network and communication signals from the IP network. It transmits the received broadcast and communication signals as a single optical signal after photoelectric conversion. The OLT 31 transfers communication signals, received from service users, to the IP network. The ONT/ONUs 32 are devices on the user side for transferring the digital broadcast and communication signals, received from the OLT 31, to the service users, and transferring communication signals from the service users to the OLT 31. The WDM demultiplexer 33 WDM-demultiplexes the digital broadcast and communication signals λ₁ to λₙ, and transfers them to the ONT/ONUs 32. The WDM multiplexer 34 WDM-multiplexes communication signals λ₁ to λₙ from the ONT/ONUs 32, and transfers them to the OLT 31.

For analog broadcast transmission, the OLT 31 includes an optical amplifier 310 for amplifying an analog broadcast signal, and an optical coupler 320 for combining the analog broadcast signal with digital broadcast and communication signals. The WDM-PON further includes an optical splitter 35, a photoelectric converter 36, and an Radio Frequency (RF) splitter 37. The optical splitter 35 splits the broadcast and communication signals from the OLT 31 into an analog broadcast signal of λ_{A} and digital broadcast and communication signals of λ₁ to λ₃₂. The photoelectric converter 36 photoelectrically converts the analog broadcast signal λ_{A}, split by the optical splitter 35, into an electric analog broadcast signal. The RF splitter 37 distributes the electric analog broadcast signal to each of the ONT/ONUs 32.

In more detail, the OLT 31 includes a broadcast switch 311, a broadcast channel controller 312, a first Ethernet switch 313, a communication/broadcast multiplexer 314, a second Ethernet switch 315, an optical transmitter 316, an optical receiver 317, a WDM multiplexer 318, and a WDM demultiplexer 319. The broadcast switch 311 switches Motion Picture Experts Group (MPEG) broadcast data of multiple channels. The broadcast channel controller 312 selects a broadcast channel at the request of a service user. The first Ethernet switch 313 switches the communication data to the higher-level IP network or to the communication/broadcast multiplexer 314 for its transmission to the ONT/ONU 32. The communication/broadcast multiplexer 314 multiplexes the communication data and the digital broadcast data. The second Ethernet switch 315 switches communication data from the service user and channel information of a digital broadcast channel desired by the service user, while separating the communication data from the channel information. The optical transmitter 316 electro-optically converts the multiplexed communication/broadcast data. The optical receiver 317 receives the communication data from the service user, which is transmitted from the ONT/ONU 32, and photoelectrically converts the received communication data. The WDM multiplexer 318 multiplexes wavelength signals, which are optically modulated. The WDM demultiplexer 319 separates the optical signals, transmitted from the ONT/ONUs 32, from each other on a wavelength-by-wavelength basis. The OLT 31 may further include an optical amplifier 310 for amplifying analog broadcast signals for analog broadcast transmission, and an optical coupler 320 for combining the analog broadcast signal with the communication and digital broadcast signals.

The ONT/ONU 32 includes an optical receiver 323, a communication/broadcast demultiplexer 321, a hub switch 322, and an optical transmitter 324. The optical receiver 323 receives communication/broadcast optical signals transmitted from the OLT 31, and photoelectrically converts them. The communication/broadcast demultiplexer 321 separates the communication and digital broadcast signals. The hub switch 322 joins together communication data from a service user and digital broadcast selection data for selecting a digital broadcast channel desired by the service user. The optical transmitter 324 electro-optically converts data to transmit it to the OLT 31.

A description will now be given of the downstream transmission operation of the WDM-PON of FIG. 3 according to Korean application No. 2003-16373. The downstream transmission indicates transmission in the direction from the OLT 31 to the ONT/ONU 32.

First, MPEG digital broadcast data transferred from an Service Operator (SO), etc., is inputted to the broadcast switch 311. Each service user specifies a TV channel that he or she desires to see. The broadcast channel selection controller 312 transfers a signal for specifying the TV channel to the broadcast switch 311 to select a digital broadcast channel desired by each service user, so that only the selected broadcast channel signal is transmitted. Taking into consideration that each service user may request a number of digital broadcast channels, the broadcast switch 311 switches up to K digital broadcast channels. In the WDM-PON of FIG. 3, the maximum number of transmittable digital broadcast channels may be set according to specifications of the WDM-PON, because a number of broadcast receivers may be equipped in a single residence.

Communication data transmitted from the higher-level IP network is switched in the first Ethernet switch 313 on a user-by-user basis. The communication data, together with the digital broadcast signals, is then inputted to the communication/broadcast multiplexer 314. The communication/broadcast multiplexer 314 multiplexes the inputted communication and broadcast data into a single channel using a multiplexing technique such as Time Division Multiplexing (TDM) and Frequency Division Multiplexing (FDM).

The communication and digital broadcast data multiplexed in the communication/broadcast multiplexer 314 are electro-optically converted in the optical transmitters 316 which have unique transmission wavelengths λ₁ to λₙ, respectively.

After being multiplexed in the WDM multiplexer 318, the optically-modulated communication/broadcast data is combined, by the optical coupler 320, with an analog broadcast optical signal of λ_{A} amplified in the optical amplifier 310.

The combined wavelength-multiplexed optical signal is transmitted through an optical cable. The analog broadcast optical signal λ_{A} is separated from the combined optical signal by an optical splitter 35 on the receiver side. The communication/broadcast-multiplexed optical signals of λ₁ to λₙ are separated from each other by the WDM demultiplexer 33 according to their wavelength, and are then photoelectrically converted by the optical receiver 323 in each ONT/ONU 32.

After the photoelectrical conversion, the communication/broadcast-multiplexed signal is demultiplexed by the communication/broadcast demultiplexer 321 into K digital broadcast channels and communication data. They are then transferred to a terminal device of the service user, such as a digital TV and a computer.

The analog broadcast optical signal split through the optical splitter 35 is photoelectrically converted in the optical receiver 36, and the converted electrical signal is split through the RF splitter 37 to be transferred to each service user.

Upstream transmission operation is performed in the following manner. The upstream transmission indicates transmission in the direction from the ONT/ONU 32 to the OLT 31.

Signals transmitted from each service user to the OLT 31 are composed mainly of IP communication data generated by a computer, etc., and a broadcast channel selection signal for viewing a desired broadcast channel. These signals are combined in the hub switch 322 in the ONT/ONU 32, and the combined signal is electro-optically converted in the optical transmitter 324 with a transmission wavelength assigned to each of the ONT/ONUs 32. The converted signal is multiplexed in the WDM multiplexer 34 with wavelength signals from the other ONT/ONUs 32.

The multiplexed WDM optical signals are transmitted to the OLT 31 through an optical cable. They are then separated from each other according to their wavelength by the WDM demultiplexer 319 in the OLT 31.

The wavelength signals separated according to their wavelength are photoelectrically converted in the optical receivers 317, and the converted electrical signals are inputted to the second Ethernet switch 315. This switch 315 switches the broadcast channel selection signal to the broadcast channel selection controller 312, and switches the IP communication data to the first Ethernet switch 313 connected to the IP network.

The signal inputted to the broadcast channel selection controller 312 is used to control the broadcast switch 311 The signal inputted to the first Ethernet switch 313 is transferred to the higher-level IP network.

A detailed configuration of the communication/broadcast multiplexer and demultiplexer 314 and 321 for integrating and separating communication and broadcast signals has not been set forth in the WDM-PON capable of integrating broadcast and communication according to Korean application No. 2003-16373. Thus, there is a need to study a configuration of the communication/broadcast multiplexer and demultiplexer 314 and 321, which enables the use of general protocols. It is also necessary to modify the WDM-PON according to Korean application No. 2003-16373 so as to be capable of providing a Triple Play Service (TPS) in which a voice communication service is provided as a service independent of broadcast/communication services. This has been generally provided in the form of Voice over IP (VoIP) packets included in an Ethernet frame transmitted for the communication service.

### SUMMARY OF THE INVENTION

Therefore, the present invention has been made in view of the above circumstances and needs. I It is an object of the present invention to provide a communication/broadcast multiplexer and demultiplexer for multiplexing and demultiplexing communication and broadcast signals using a specific transmission standard in an optical network system that integrates broadcast and communication services using a channel selection technique.

It is another object of the present invention to provide a communication/broadcast multiplexer and demultiplexer for implementing TPS services in a WDM PON-based FTTH system.

In accordance with one aspect of the present invention, a communication/broadcast multiplexer is provided for use with digital broadcast data and communication data and a broadcast/communication-integrated system, the multiplexer comprising a broadcast data receiver, wherein the broadcast data receiver receives broadcast data on a subscriber basis in the broadcast/communication-integrated system, and transfers the broadcast data as a synchronous data frame; a communication data receiver, wherein the communication data receiver receives communication data on a subscriber basis and transfers the communication data as an asynchronous data frame; and a synchronous Ethernet framer for converting both the synchronous data frame received from the broadcast data receiver and the asynchronous data frame received from the communication data receiver into a synchronous Ethernet frame.

In accordance with another aspect of the present invention, there is provided a communication/broadcast demultiplexer for use with digital broadcast data and communication data and a broadcast/communication-integrated system, the demultiplexer comprising a synchronous Ethernet deframer for dividing a synchronous Ethernet frame received in the broadcast/communication-integrated system into broadcast data corresponding to a synchronous data frame and communication data corresponding to an asynchronous data frame, and a broadcast data output unit for separating the broadcast data received from the synchronous Ethernet deframer into respective broadcast signals of channels, and then outputting the broadcast signals.

In accordance with a further aspect of the present invention, there is provided a communication/broadcast multiplexer for use with digital broadcast data and communication data and a broadcast/communication-integrated system, the multiplexer comprising an Ethernet Media Access Control (MAC) framer for receiving MPEG-TS signals switched on a subscriber basis through a broadcast switch in an OLT in the broadcast/communication-integrated system, and converting the MPEG-TS signals into an Ethernet MAC frame; and an Ethernet MAC switch for switching the Ethernet MAC frame for broadcasting received from the Ethernet MAC framer and an Ethernet MAC frame for communication received on a subscriber basis through an Ethernet switch in the OLT.

In accordance with another aspect of the present invention, there is provided a communication/broadcast demultiplexer for use with digital broadcast data and communication data and a broadcast/communication-integrated system, the demultiplexer comprising an Ethernet Media Access Control (MAC) switch for separating an Ethernet frame received through a photoelectric converter in a corresponding ONT in the broadcast/communication-integrated system into an Ethernet MAC frame for communication and an Ethernet MAC frame for broadcasting; and a MAC deframer for converting the separated Ethernet MAC frame for broadcasting back to MPEG-TS data.

In accordance with yet another aspect of the present invention, there is provided a communication/broadcast multiplexer for use with digital broadcast data and communication data in a broadcast/communication-integrated system, the multiplexer comprising an IEEE 1394 link layer controller (LLC) for receiving MPEG-TS signals switched on a subscriber basis in the broadcast/communication-integrated system, receiving communication data on a subscriber basis through an Ethernet switch, and converting both the MPEG-TS signals and the communication data into IEEE 1394 data; and a controller connected with the IEEE 1394 LLC to allow the IEEE 1394 LLC to convert both the MPEG-TS signals and the communication data into the IEEE 1394 data.

In accordance with a further aspect of the present invention, there is provided a communication/broadcast demultiplexer for use with digital broadcast data and communication data and a broadcast/communication-integrated system, the demultiplexer comprising an IEEE 1394 physical unit for receiving IEEE 1394 data transmitted to a corresponding optical network terminal (ONT) in the broadcast/communication-integrated system; an IEEE 1394 link layer controller (LLC) for dividing the IEEE 1394 data received through the IEEE 1394 physical unit into MPEG-TS signals and communication data; and a controller connected with the IEEE 1394 LLC to allow the IEEE 1394 LLC to divide the received IEEE 1394 data into the MPEG-TS signals and the communication data.

In accordance with another aspect of the present invention, there is provided a communication/broadcast multiplexer for use with digital broadcast data and communication data and a broadcast/communication-integrated system including a voice matching unit for voice transmission, the multiplexer comprising an IEEE 1394 link layer controller (LLC) for receiving MPEG-TS signals switched on a subscriber basis through a broadcast switch in an optical line terminal (OLT) in the broadcast/communication-integrated system, receiving a voice signal from the voice matching unit, receiving communication data on a subscriber basis through an Ethernet switch in the OLT, and converting the MPEG-TS signals, the voice signal, and the communication data into IEEE 1394 data; and a controller connected with the IEEE 1394 LLC to allow the IEEE 1394 LLC to convert the MPEG-TS signals, the voice signal, and the communication data into the IEEE 1394 data.

In accordance with yet another aspect of the present invention, there is provided a communication/broadcast demultiplexer for use with digital broadcast data and communication data and a broadcast/communication-integrated system, the demultiplexer comprising an IEEE 1394 physical unit for receiving IEEE 1394 data transmitted to a corresponding optical network terminal (ONT) in the broadcast/communication-integrated system; an IEEE 1394 link layer controller (LLC) for dividing the IEEE 1394 data received through the IEEE 1394 physical unit into MPEG-TS signals, a voice signal, and communication data; and a controller connected with the IEEE 1394 LLC to allow the IEEE 1394 LLC to divide the received IEEE 1394 data into the MPEG-TS signals, the voice signal, and the communication data.

### BRIEF DESCRIPTION OF THE DRAWINGS

The present invention will be more clearly understood from the following detailed description taken in conjunction with the accompanying drawings, in which:

FIG. 1 is a block diagram illustrating the configuration of a conventional WDM-PON capable of integrating broadcast and communication;

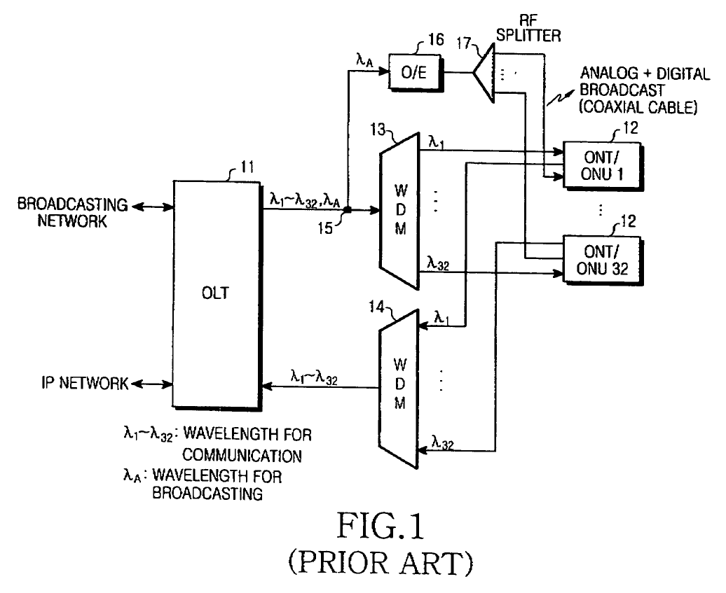

FIG. 2 is a block diagram illustrating the configuration of another conventional WDM-PON capable of integrating broadcast and communication;

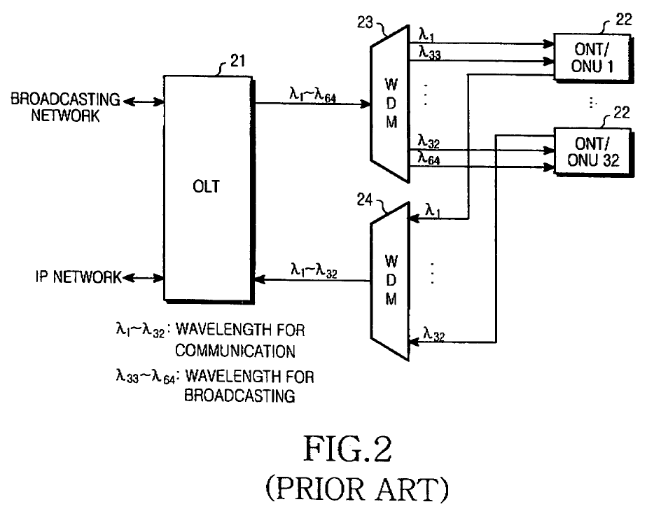

FIG. 3 is a block diagram illustrating the configuration of a WDM-PON capable of integrating broadcast and communication according to Korean application No. 2003-16373;

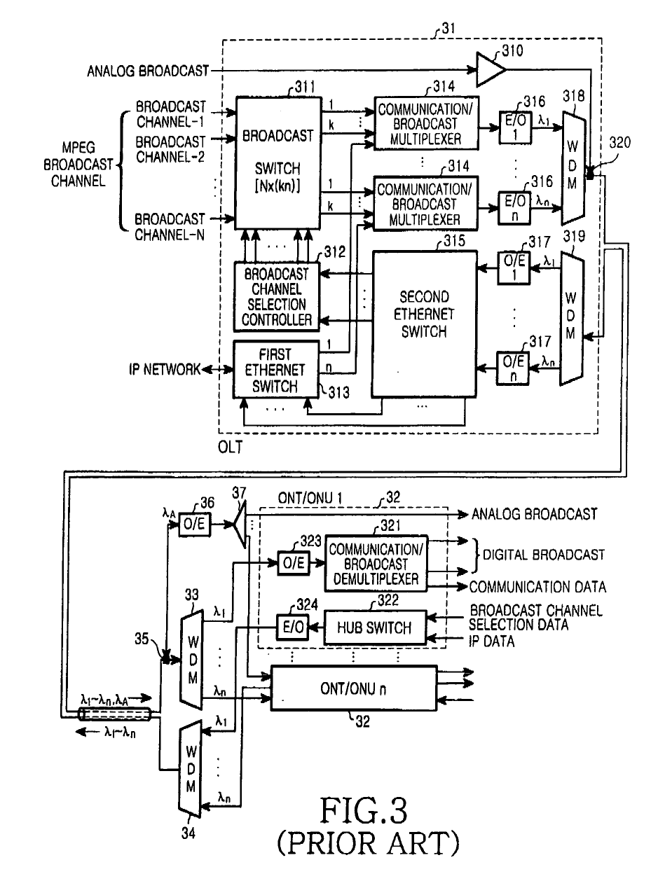

FIGS. 4a and 4b are block diagrams illustrating the respective configurations of a communication/broadcast multiplexer and a communication/broadcast demultiplexer according to a first embodiment of the present invention;

FIG. 5 illustrates a data structure for synchronous Ethernet according to the present invention;

FIGS. 6a and 6b are block diagrams illustrating the respective configurations of a communication/broadcast multiplexer and a communication/broadcast demultiplexer according to a second embodiment of the present invention;

FIGS. 7a and 7b are block diagrams illustrating the respective configurations of a communication/broadcast multiplexer and a communication/broadcast demultiplexer according to a third embodiment of the present invention;

FIG. 8 illustrates a data structure for IEEE 1394 transmission according to the present invention;

FIGS. 9a and 9b are block diagrams illustrating the respective configurations of a communication/broadcast multiplexer and a communication/broadcast demultiplexer according to a fourth embodiment of the present invention, which is modified from the third embodiment to provide TPS services; and

FIG. 10 illustrates an IEEE 1394 data structure for providing TPS services according to the present invention.

### DETAILED DESCRIPTION

Now, embodiments of the present invention will be described in detail with reference to the annexed drawings. In the drawings, the same or similar elements are denoted by the same reference numerals even though they are depicted in different drawings. For the purposes of clarity and simplicity, a detailed description of known functions and configurations incorporated herein will be omitted as it may make obscure the subject matter of the present invention.

The following description of the present invention will be given with reference to a PON (Passive Optical Network) that uses WDM (Wavelength Division Multiplexing) to integrate and transmit digital broadcasting and communication signals according to Korean application No. 2003-16373. The present invention is not limited to this PON structure, which is provided only for illustrative purposes, and may be applied to various other PON structures that enable the integration of communication and broadcast services.

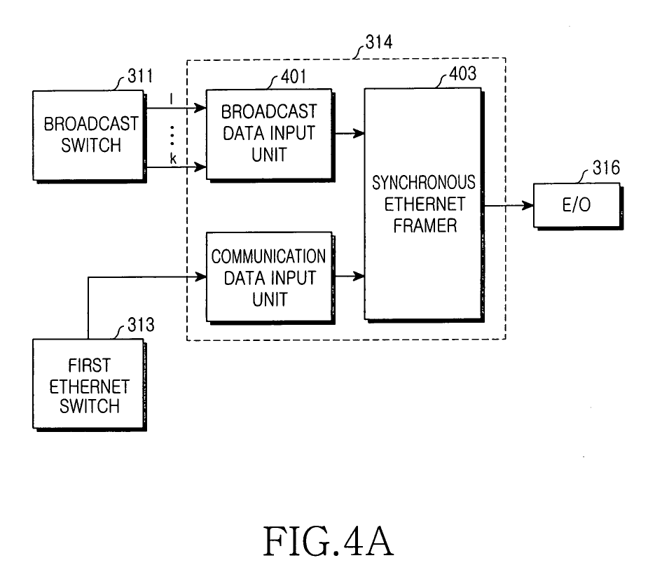

FIGS. 4a and 4b are block diagrams illustrating the respective configurations of a communication/broadcast multiplexer and a communication/broadcast demultiplexer according to a first embodiment of the present invention.

The communication/broadcast multiplexer according to the first embodiment uses synchronous Ethernet for communication/broadcast multiplexing.

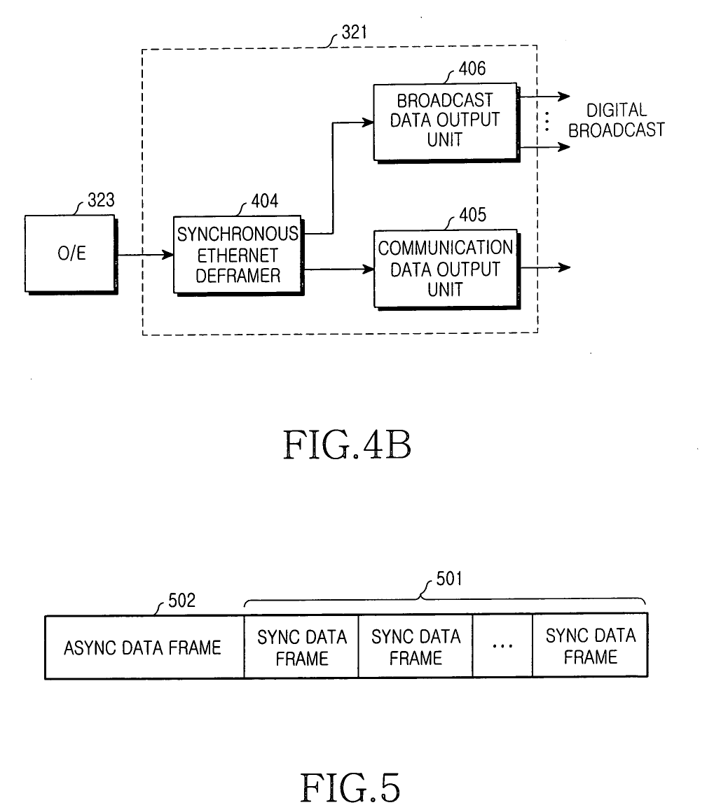

FIG. 5 illustrates a data structure for synchronous Ethernet. As shown in FIG. 5, synchronous Ethernet data includes an asynchronous data frame 502 and a plurality of synchronous data frames 501. According to the synchronous Ethernet, when conventional communication data including Ethernet data and control data is transmitted together with data (for example, multimedia data such as MPEG-TS) requiring real-time processing, the data requiring real-time processing is transmitted synchronously with a predetermined cycle, thereby minimizing the delay of the data requiring real-time processing. The synchronous Ethernet satisfies IEEE 802.3, making it possible to accommodate communication/broadcast services using the conventional Ethernet physical layer without alteration.

Broadcast data of K broadcast channels are framed into a number of synchronous data frames 501 having the conventional size of 830 octets. The maximum allowed number of the synchronous data frames 501 is 16. Communication data (for example, general Ethernet data) is incorporated into the asynchronous data frame 502. The synchronous and asynchronous frames 501 and 502 constitute one cycle (8 kHz). These frames are synchronized at intervals of 125 μs. The synchronous data frames are preferentially transmitted. This allows data transmission with the minimum broadcast service delay. The physical structure for downstream transmission from the OLT to the ONT complies with IEEE 802.3 described above, and upstream transmission from the ONT to the OLT carries only Ethernet data including control data (for example, zapping and NMS/EMS data), other than broadcast data.

As shown in FIG. 4a, the communication/broadcast multiplexer according to the first embodiment of the present invention includes a broadcast data input unit 401, a communication data input unit 402, and a synchronous Ethernet framer 403. The broadcast data input unit 401 receives broadcast data switched on a subscriber basis through a broadcast switch 311, and inputs the broadcast data, as a synchronous data frame, to the synchronous Ethernet framer 403. The communication data input unit 402 receives communication data through a first Ethernet switch 313 and inputs the communication data, as an asynchronous data frame, to the synchronous Ethernet framer 403. The synchronous Ethernet framer 403 produces a Time Division Multiplexed (TDM) synchronous Ethernet frame corresponding to the data received from the input units 401 and 402. It outputs the produced frame to an electro-optical converter (E/O) 316.

As shown in FIG. 4b, the communication/broadcast demultiplexer according to the first embodiment of the present invention includes a synchronous Ethernet deframer 404, a communication data output unit 405, and a broadcast data output unit 406. The synchronous Ethernet deframer 404 divides a synchronous Ethernet frame received through a photoelectric converter (O/E) 323 into broadcast data (i.e., synchronous data frames) and communication data (i.e., an asynchronous data frame), and outputs the broadcast data to the broadcast data output unit 406 and the communication data to the communication data output unit 405. The communication data output unit 405 outputs the communication data received from the synchronous Ethernet deframer 404. The broadcast data output unit 406 separates the broadcast data received from the synchronous Ethernet deframer 404 into the respective broadcast signals of channels, and then provides the signals to each user device.

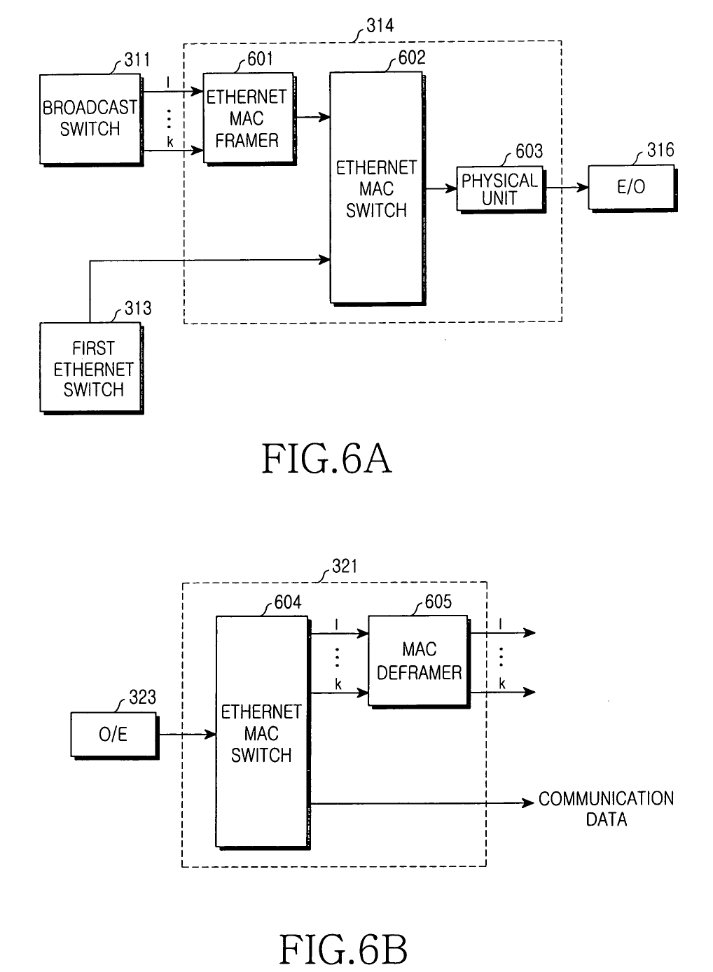

FIGS. 6a and 6b are block diagrams illustrating the respective configurations of a communication/broadcast multiplexer and a communication/broadcast demultiplexer according to a second embodiment of the present invention.

The communication/broadcast multiplexer according to the second embodiment uses an Ethernet MAC framer for communication/broadcast multiplexing.

As shown in FIG. 6a, the communication/broadcast multiplexer 314 according to the second embodiment includes an Ethernet MAC framer 601, an Ethernet MAC switch 602, and an output physical unit 603. The communication/broadcast multiplexer 314 incorporates broadcast signals into an Ethernet MAC frame in the following manner. The Ethernet MAC framer 601 in the communication/broadcast multiplexer 314 receives MPEG-TS signals switched on a subscriber basis through a broadcast switch 311. It allocates source and destination addresses to each of the MPEG-TS signals, and then incorporates the MPEG-TS signals into an Ethernet MAC frame. The Ethernet MAC frame for broadcasting, output from the Ethernet MAC framer 601, is input to the Ethernet MAC switch 602 in the communication/broadcast multiplexer 314. An Ethernet MAC frame for communication received through the first Ethernet switch 313 is also input to the Ethernet MAC switch 602.

Different source addresses and different destination addresses are allocated to the MPEG-TS signals, thereby making it possible to accommodate multiple channels. That is, a number of channels for transmission are discriminated by different source addresses, and user devices are discriminated by different destination addresses.

The Ethernet MAC switch 602 receives the Ethernet MAC frame for communication from the first Ethernet switch 313 and the Ethernet MAC frame for broadcasting from the broadcast switch 311, and switches the frames to the output physical unit 603. The Ethernet MAC switch 602 preferentially switches the Ethernet MAC frame for broadcasting to the output physical unit 603. The switched data is transferred to an electro-optical converter 316, which converts the frame into an optical signal.

The communication/broadcast demultiplexer according to the second embodiment uses an Ethernet MAC deframer for communication/broadcast demultiplexing.

As shown in FIG. 6b, the communication/broadcast demultiplexer 321 according to the second embodiment includes an Ethernet MAC switch 604, and a MAC deframer 605. he communication/broadcast demultiplexer 321 demultiplexes communication/broadcast-integrated data transferred to the ONT. The Ethernet MAC switch 604 separates the communication/broadcast-integrated data received through a photoelectric converter (O/E) 323 into an Ethernet MAC frame for communication and an Ethernet MAC frame for broadcasting according to their source and destination addresses. The MAC deframer 605 converts the Ethernet MAC frame for broadcasting back to MPEG-TS data, and outputs the MPEG-TS data.

Upstream transmission from the ONT to the OLT carries only Ethernet data including NMS/EMS data and a zapping signal, other than broadcast data.

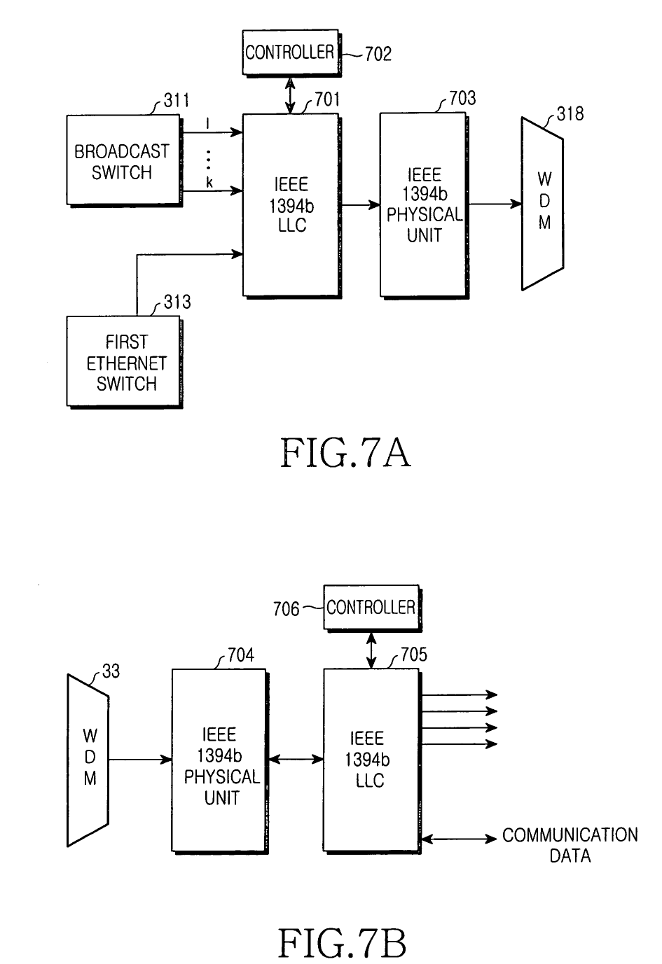

FIGS. 7a and 7b are block diagrams illustrating the respective configurations of a communication/broadcast multiplexer and a communication/broadcast demultiplexer according to a third embodiment of the present invention.

The communication/broadcast multiplexer according to the third embodiment uses IEEE 1394 transmission for communication/broadcast multiplexing.

IEEE 1394a, which is one version of the IEEE 1394 used in the embodiments of the present invention, theoretically supports up to 400 Mbps. IEEE 1394b, which is another version thereof, theoretically supports up to 3.2 Gbps, and is backwards compatible.

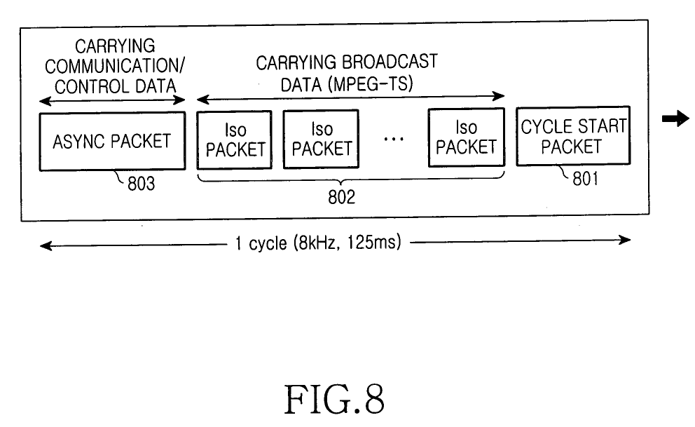

FIG. 8 illustrates a data structure for IEEE 1394 transmission. As shown in FIG. 8, an IEEE 1394 frame has a cycle of 125 μs, and supports two data formats. The first is an isochronous data format 802 suitable for transmission of a broadcast MPEG-TS and the second is an asynchronous data format 803 suitable for transmission of communication data and control signals. To accommodate multiple channels for broadcasting, the present invention utilizes the fact that a number of isochronous data packets can be accommodated in the IEEE 1394 transmission cycle (125 μs). That is, the IEEE 1394 frame accommodates multiple broadcast channels using a number of isochronous data packets in the IEEE 1394 transmission cycle (125 μs). Theoretically, the IEEE 1394 frame can support up to 64 channels.

As shown in FIG. 7a, the communication/broadcast multiplexer using IEEE 1394 according to the third embodiment includes an IEEE 1394b Link Layer Controller (LLC) 701, an IEEE 1394b physical unit 703, and a controller 702. The communication/broadcast multiplexer converts K digital broadcast channels from a broadcast switch 311 and communication data from a first Ethernet switch 313 into an IEEE 1394 transmission frame. It also WDM-multiplexes and transmits the IEEE 1394 transmission frame to a corresponding ONT.

The communication/broadcast demultiplexer according to the third embodiment uses IEEE 1394 transmission for communication/broadcast demultiplexing.

As shown in FIG. 7b, the communication/broadcast demultiplexer provided in an ONT, which uses IEEE 1394 according to the third embodiment, includes an IEEE 1394b physical unit 704, an IEEE 1394b LLC 705, and a controller 706.

The IEEE 1394b physical unit 704 receives optical transmission data for the ONT through a WDM demultiplexer 33, and photoelectrically converts and transfers the received data to the IEEE 1394b LLC 705. Under the control of the controller 706, the IEEE 1394b LLC 705 divides the received IEEE 1394 transmission data into broadcast and communication packets, and transmits the packets.

Upstream transmission from the ONT to the OLT carries only Ethernet data including NMS/EMS data and a zapping signal, other than broadcast data.

A physical unit, which can provide IEEE 1394b standard output, among various commercial chips supporting IEEE 1394, and an IEEE 1394 LLC capable of providing a multimedia data stream interface may be used in practical implementations of the communication/broadcast multiplexer and demultiplexer supporting IEEE 1394. Here, the IEEE 1394 LLC is designed to have a predetermined number of controllable buffers and a data interface.

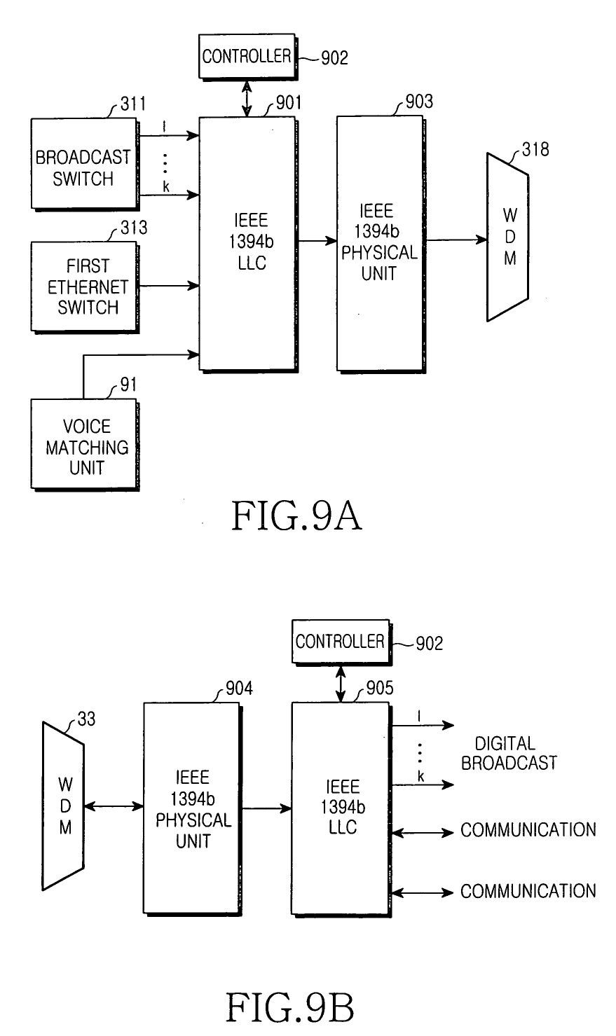

FIGS. 9a and 9b are block diagrams illustrating the respective configurations of a communication/broadcast multiplexer and a communication/broadcast demultiplexer according to a fourth embodiment of the present invention. This embodiment provides TPS services.

Two typical methods are used to support TPS services. In the first method, an Ethernet frame is used to carry all three types of data, i.e., broadcast, communication and voice data. In the second method, broadcast data separated from communication data is transmitted using an independent channel, and voice data is transmitted by incorporating it into the communication data.

Since the first method transmits broadcast and voice data using an Ethernet frame, the first method requires a large amount of processing to guarantee real-time transmission and the quality of signal transmission. This requirement causes a problem in practical implementations. In particular, a priority-based method for guaranteeing the quality of transmission causes a decrease in the quality of transmission of broadcast and voice data. In this method, all broadcast, voice and communication data is accommodated in limited Ethernet resources, which causes significant problems such as bandwidth decrease and transmission quality decrease.

As described above, the second method transmits broadcast data through an independent channel, and transmits communication and voice data in an Ethernet frame. Since there is independent transmission of the broadcast data, the second method can guarantee bandwidth for communication and voice data transmission. However, a high cost is incurred for the broadcast data transmission and reception, and the Ethernet transmission of the voice data causes a problem in the real-time service.

The present invention is characterized in that the IEEE 1394 multiplexer/demultiplexer are used to provide TPS (Triple Play Service) services.

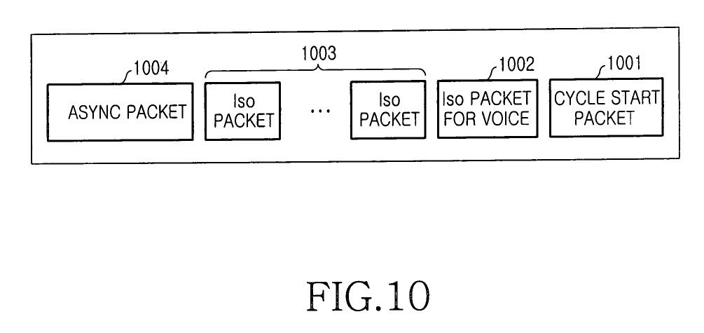

FIG. 10 illustrates an IEEE 1394 data structure for providing TPS services.

As with the IEEE 1394 frame of FIG. 8, an IEEE 1394 frame of FIG. 10 has a cycle of 125 μs, and supports two data formats, i.e., isochronous and asynchronous data formats. The isochronous data format suitable for real-time multimedia data transmission gives priority consideration to transmission timing. The isochronous data is preferentially transmitted over the asynchronous data, and is allocated up to 80% of the available transmission resources The asynchronous data is allocated at least 20% thereof, and gives priority consideration to transmission quality.

Isochronous and asynchronous data can be allocated to multiple channels in a transmission cycle of 125 μs. Accordingly, broadcast data is allocated to isochronous data packets 1003, and communication and control data is allocated to an asynchronous data packet 1004. Since the characteristics of voice data are similar to those of broadcast data, voice data is designed to be allocated to the isochronous data packet 1002 and transmitted over a single channel corresponding to the isochronous data packet 1002.

As shown in FIG. 9a, the communication/broadcast multiplexer for providing TPS services according to the fourth embodiment of the present invention includes an IEEE 1394b LLC (Link Layer Controller) 901, an IEEE 1394b physical unit 903, and a controller 902. The communication/broadcast multiplexer in an OLT converts K digital broadcast channels from a broadcast switch 311 and communication data from a first Ethernet switch 313 into an IEEE 1394 transmission frame. The WDM-multiplexes and transmits the IEEE 1394 transmission frame to a corresponding ONT. In this embodiment, a voice matching unit 91 for voice data transmission is additionally provided in the OLT. The IEEE 1394b LLC receives voice data from the voice matching unit 91, and multiplexes the voice data into an IEEE 1394 data frame as shown in FIG. 10. The controller 902 is connected to the IEEE 1394b LLC 901 to control the flow of broadcast data. It provides a communication data path, handles voice data transmission, and performs control signal processing such as channel zapping.

As shown in FIG. 9b, the communication/broadcast demultiplexer according to the fourth embodiment of the present invention, which is provided in an ONT, uses IEEE 1394 to provide TPS services, and includes an IEEE 1394b physical unit 904, an IEEE 1394b LLC 905, and a controller 906.

The IEEE 1394b physical unit 904 receives optical transmission data for the ONT through a WDM demultiplexer 33, and photoelectrically converts and transfers the received data to the IEEE 1394b LLC 905. Under the control of the controller 906, the IEEE 1394b LLC 905 divides the received IEEE 1394 transmission data into communication, broadcast and voice packets, and transmits the packets. The controller 902 is connected to the IEEE 1394b LLC 905. It controls the flow of broadcast data, provides a communication data path, handles voice data transmission, and performs control signal processing such as channel zapping.

Upstream transmission from the ONT to the OLT carries only Ethernet data including NMS/EMS data and a zapping signal, other than broadcast data.

A physical unit can provide IEEE 1394b standard output, among various commercial chips supporting IEEE 1394, and an IEEE 1394 LLC capable of providing a multimedia data stream interface. The physical unit may be used in practical implementations of the communication/broadcast multiplexer and demultiplexer supporting IEEE 1394. Here, the IEEE 1394 LLC is designed to have a predetermined number of controllable buffers and a data interface.

Each of the IEEE 1394b physical units 703, 704, 903 and 904 can provide an optical interface in the IEEE 1394b transmission as shown in FIGS. 7 to 10. Each physical unit can transfer data directly to a WDM-PON light source without requiring a photoelectric converter or an electro-optical converter.

In the IEEE 1394b transmission as shown in FIGS. 7 to 10, multiple channels for broadcasting can be accommodated. The present invention utilizes the fact that a number of isochronous channels can be accommodated in an IEEE 1394 transmission cycle of 125 μs. For example, where the system is designed for a maximum transmission capacity of 400 Mbps, if asynchronous transmission resources of 100 Mbps are allocated to transmission of communication data, isochronous transmission resources may have a transmission capacity of up to 300 Mbps. The resources may be allocated to transmission of isochronous data packets of various lengths.

For example, in the IEEE 1394b transmission as shown in FIGS. 7 to 10, it is possible to support up to 6 broadcast channels of 50 Mbps. It is also possible to transmit up to 11 broadcast channels of 27 Mbps to one subscriber. An actual bandwidth capacity required for transmission of voice data is in the range of 2 to 3 Mbps, which is smaller than that required for transmission of broadcast and communication data.

As apparent from the above description, a communication/broadcast multiplexer and demultiplexer according to the present invention has the following features and advantages. In an optical network system for integrating broadcast and communication services using a channel selection technique, the communication/broadcast multiplexer and demultiplexer multiplex and demultiplex communication/broadcast data according to a generalized physical transmission standard, thereby making it possible to implement a low-price WDM-PON system.

The communication/broadcast multiplexer and demultiplexer use an IEEE 1394 standard transmission protocol to implement TPS services, thereby making it possible to guarantee both the quality of broadcast and voice signals and the bandwidth for communication signals.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention should not be limited to the above embodiments, but should rather defined by the accompanying claims as well as equivalents thereof.

What is claimed is:

1. A communication/broadcast multiplexer for use with digital broadcast data and communication data and a broadcast/communication-integrated system, the multiplexer comprising:
a broadcast data receiver, wherein the broadcast data receiver receives broadcast data on a subscriber basis in the broadcast/communication-integrated system, and transfers the broadcast data as a synchronous data frame;
a communication data receiver, wherein the communication data receiver receives communication data on a subscriber basis and transfers the communication data as an asynchronous data frame; and
a synchronous Ethernet framer for converting both the synchronous data frame received from the broadcast data receiver and the asynchronous data frame received from the communication data receiver into a synchronous Ethernet frame.

2. The multiplexer according to claim 1, wherein the broadcast data is received on a subscriber basis uses a broadcast switch in an optical line terminal in the broadcast/communication-integrated system.

3. The multiplexer according to claim 1, wherein the communication data is received through an Ethernet switch in a optical line terminal.

4. The multiplexer according to claim 1, wherein the synchronous Ethernet frame is a Time Division Multiplexed synchronous Ethernet frame.

5. The multiplexer according to claim 1, wherein the synchronous Ethernet framer is further configured to output the synchronous Ethernet frame.

6. The multiplexer according to claim 1, wherein the synchronous Ethernet framer gives priority to transmission of the synchronous data frame over the asynchronous data frame.

7. A communication/broadcast demultiplexer for use with digital broadcast data and communication data and a broadcast/communication-integrated system, the demultiplexer comprising:
a synchronous Ethernet deframer for dividing a synchronous Ethernet frame received in the broadcast/communication-integrated system into broadcast data corresponding to a synchronous data frame and communication data corresponding to an asynchronous data frame; and
a broadcast data output unit for separating the broadcast data received from the synchronous Ethernet deframer into respective broadcast signals of channels, and then outputting the broadcast signals.

8. The communication/broadcast demultiplexer according to claim 7, wherein the synchronous Ethernet frame is received using a photoelectric converter in an optical line terminal.

9. The communication/broadcast demultiplexer according to claim 7, further including a communication data output unit for outputting the communication data received from the synchronous Ethernet deframer to a subscriber device.

10. A communication/broadcast multiplexer for use with digital broadcast data and communication data and a broadcast/communication-integrated system, the multiplexer comprising:
an Ethernet Media Access Control (MAC) framer for receiving MPEG-TS signals switched on a subscriber basis through a broadcast switch in an OLT in the broadcast/communication-integrated system, and converting the MPEG-TS signals into an Ethernet MAC frame; and
an Ethernet MAC switch for switching the Ethernet MAC frame for broadcasting received from the Ethernet MAC framer and an Ethernet MAC frame for communication received on a subscriber basis through an Ethernet switch in the OLT.

11. The multiplexer according to claim 10, wherein the Ethernet MAC framer allocates source and destination addresses to each of the MPEG-TS signals to convert the MPEG-TS signals into the Ethernet MAC frame.

12. The multiplexer according to claim 11, wherein different source addresses and different destination addresses are allocated to the MPEG-TS signals.

13. The multiplexer according to any one of claims 10, wherein the Ethernet MAC switch preferentially switches the Ethernet MAC frame for broadcasting by giving priority to switching of the Ethernet MAC frame for broadcasting over switching of the Ethernet MAC frame for communication.

14. A communication/broadcast demultiplexer for use with digital broadcast data and communication data and a broadcast/communication-integrated system, the demultiplexer comprising:
an Ethernet Media Access Control (MAC) switch for separating an Ethernet frame received through a photoelectric converter in a corresponding ONT in the broadcast/communication-integrated system into an Ethernet MAC frame for communication and an Ethernet MAC frame for broadcasting; and
a MAC deframer for converting the separated Ethernet MAC frame for broadcasting back to MPEG-TS data.

15. The communication/broadcast demultiplexer according to claim 14, wherein the MAC deframer is further configured to output the MPEG-TS data.

16. The demultiplexer according to claim 14, wherein the Ethernet MAC switch separates the Ethernet frame received through the photoelectric converter into the Ethernet MAC frame for communication and the Ethernet MAC frame for broadcasting, according to source and destination addresses of each of the frames.

17. A communication/broadcast multiplexer for use with digital broadcast data and communication data in a broadcast/communication-integrated system, the multiplexer comprising:
an IEEE 1394 link layer controller (LLC) for receiving MPEG-TS signals switched on a subscriber basis in the broadcast/communication-integrated system, receiving communication data on a subscriber basis through an Ethernet switch, and converting both the MPEG-TS signals and the communication data into IEEE 1394 data; and
a controller connected with the IEEE 1394 LLC to allow the IEEE 1394 LLC to convert both the MPEG-TS signals and the communication data into the IEEE 1394 data.

18. The multiplexer according to claim 17, wherein the MPEG-TS signals are switched using a broadcast switch in an optical lint terminal.

19. The multiplexer according to claim 17, further including an IEEE 1394 physical unit for transferring the IEEE 1394 data received from the IEEE 1394 LLC.

20. The multiplexer according to claim 17, wherein the IEEE 1394 LLC converts both the MPEG-TS signals and the communication data into the IEEE 1394 data by allocating the MPEG-TS signals to IEEE 1394 isochronous data packets and allocating the communication data to an IEEE 1394 asynchronous data packet.

21. The multiplexer according to claim 17, wherein the IEEE 1394 physical unit transmits an optical signal corresponding to the IEEE 1394 data received from the IEEE 1394 LLC.

22. A communication/broadcast demultiplexer for use with digital broadcast data and communication data and a broadcast/communication-integrated system, the demultiplexer comprising:
an IEEE 1394 physical unit for receiving IEEE 1394 data transmitted to a corresponding optical network terminal (ONT) in the broadcast/communication-integrated system;
an IEEE 1394 link layer controller (LLC) for dividing the IEEE 1394 data received through the IEEE 1394 physical unit into MPEG-TS signals and communication data; and
a controller connected with the IEEE 1394 LLC to allow the IEEE 1394 LLC to divide the received IEEE 1394 data into the MPEG-TS signals and the communication data.

23. The demultiplexer according to claim 22, wherein the IEEE 1394 LLC divides the received IEEE 1394 data into the MPEG-TS signals and the communication data by associating IEEE 1394 isochronous data packets in the received IEEE 1394 data with the MPEG-TS signals switched on a subscriber basis, and associating an IEEE 1394 asynchronous data packet therein with the communication data received on a subscriber basis.

24. The demultiplexer according to claim 22, wherein the IEEE 1394 physical unit converts an optical signal containing the IEEE 1394 data received by the ONT into an electrical signal and transfers the electrical signal to the IEEE 1394 LLC.

25. A communication/broadcast multiplexer for use with digital broadcast data and communication data and a broadcast/communication-integrated system including a voice matching unit for voice transmission, the multiplexer comprising:
an IEEE 1394 link layer controller (LLC) for receiving MPEG-TS signals switched on a subscriber basis through a broadcast switch in an optical line terminal (OLT) in the broadcast/communication-integrated system, receiving a voice signal from the voice matching unit, receiving communication data on a subscriber basis through an Ethernet switch in the OLT, and converting the MPEG-TS signals, the voice signal, and the communication data into IEEE 1394 data; and
a controller connected with the IEEE 1394 LLC to allow the IEEE 1394 LLC to convert the MPEG-TS signals, the voice signal, and the communication data into the IEEE 1394 data.

26. The multiplexer according to claim 25, further including an IEEE 1394 physical unit for transferring the IEEE 1394 data received from the IEEE 1394 LLC.

27. The multiplexer according to claim 25, wherein the IEEE 1394 LLC converts the MPEG-TS signals, the voice signal, and the communication data into the IEEE 1394 data by allocating the MPEG-TS signals and the voice signal to IEEE 1394 isochronous data packets and allocating the communication data to an IEEE 1394 asynchronous data packet.

28. The multiplexer according to claim 25, wherein the IEEE 1394 physical unit transmits an optical signal corresponding to the IEEE 1394 data received from the IEEE 1394 LLC.

29. A communication/broadcast demultiplexer for use with digital broadcast data and communication data and a broadcast/communication-integrated system, the demultiplexer comprising:
an IEEE 1394 physical unit for receiving IEEE 1394 data transmitted to a corresponding optical network terminal (ONT) in the broadcast/communication-integrated system;
an IEEE 1394 link layer controller (LLC) for dividing the IEEE 1394 data received through the IEEE 1394 physical unit into MPEG-TS signals, a voice signal, and communication data; and
a controller connected with the IEEE 1394 LLC to allow the IEEE 1394 LLC to divide the received IEEE 1394 data into the MPEG-TS signals, the voice signal, and the communication data.

30. The demultiplexer according to claim 29, wherein the communication/broadcast demultiplexer further includes outputting the MPEG-TS signals, the voice signal, and the communication data to a subscriber device.

31. The demultiplexer according to claim 29, wherein the IEEE 1394 LLC divides the received IEEE 1394 data into the MPEG-TS signals, the voice signal, and the communication data by associating IEEE 1394 isochronous data packets in the received IEEE 1394 data with the voice signal and MPEG-TS signals switched on a subscriber basis, and associating an IEEE 1394 asynchronous data packet therein with the communication data received on a subscriber basis.

32. The demultiplexer according to claim 29, wherein the IEEE 1394 physical unit converts an optical signal containing the IEEE 1394 data received by the ONT into an electrical signal and transfers the electrical signal to the IEEE 1394 LLC.
